(19) United States
(12) Patent Application Publication
(10) Pub. No.: US 2014/0177764 A1
(43) Pub. Date: Jun. 26, 2014

(54) LOW POWER PACKET DETECTION EMPLOYING SINGLE ADC

(71) Applicant: Thomas TETZLAFF, Hillsboro, OR (US)

(72) Inventor: Thomas TETZLAFF, Hillsboro, OR (US)

(21) Appl. No.: 13/722,498

(22) Filed: Dec. 20, 2012

(51) Int. Cl. H04L 27/06

(52) U.S. Cl. CPC H04L 27/06
USPC 375/343; 375/340

(57) ABSTRACT

Wireless systems, devices, and methods are presented in which a communications interface unit is configured to receive a wireless signal and includes a first channel path having a first down-converter to generate a first analog baseband signal and a first ADC to generate first digital samples as well as second channel path having a second down-converter that operates at a frequency orthogonal to the first down-converter and generates a second analog baseband signal and a second ADC to generate second digital samples. In addition, a packet detector unit is used to detect a beginning frame of packet data, wherein the second channel path is deactivated until the beginning frame of the packet data is detected and the packet detector detects the beginning frame of the packet data based on only the first digital samples provided by the first channel path.

### TECHNICAL FIELD

This disclosure relates generally to the field of wireless communication systems.

### BACKGROUND ART

By virtue of design, modern wireless communication devices employ receiver elements that are active and processing, even when the devices are not engaged in actual communications. In particular, communications based on wireless technologies, such as, for example, Wi-Fi, WiMax, WWAN, WLAN, WPAN, BlueTooth, BlueTooth Low Energy, etc. often require wireless communications devices to operate in “listening mode,” namely, detect, receive, and process signals that may include relevant packet data while the devices are not actively communicating.

Given the significant amount of time a wireless communication device may spend in listening mode as well as the energy used to maintain receiver elements active during such a mode, it will be appreciated that a substantial amount of power may be consumed by communication devices that are not actively communicating.

### BRIEF DESCRIPTION OF THE DRAWINGS

FIG. 1 depicts a high-level functional block diagram of a low power packet detection system, in accordance with various aspects of the present disclosure.

FIG. 2 a functional flow diagram of a low power packet detection process, in accordance with various aspects of the present disclosure.

### DETAILED DESCRIPTION

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

In accordance with various embodiments of this disclosure, what is disclosed are wireless systems, devices, and methods in which a communications interface unit is configured to receive a wireless signal and includes a first channel path having a first down-converter to generate a first analog baseband signal and a first ADC to generate first digital samples as well as second channel path having a second down-converter that operates at a frequency orthogonal to the first down-converter and generates a second analog baseband signal and a second ADC to generate second digital samples. In addition, a packet detector unit is used to detect a beginning frame of packet data, wherein the second channel path is deactivated until the beginning frame of the packet data is detected and the packet detector detects the beginning frame of the packet data based on only the first digital samples provided by the first channel path.

These and other features and characteristics, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of claims. As used in the specification and in the claims, the singular form of “a”, “an”, and “the” include plural referents unless the context clearly dictates otherwise.

By way of review, the inventor has observed that a substantial amount of power may be consumed by wireless communication devices during the listening modes specified by various wireless technologies/standards. Such power consumption may be due, in part, to elements of the receiver chain, such as, for example, radio-frequency (RF)/intermediate-frequency (IF) down-converters, analog/digital converters (ADCs), packet detection modules, etc. that are actively receiving and processing signals in an effort to detect relevant packet data. Generally, many wireless communication devices maintain both, in-phase (I-channel) and quadrature-phase (Q-channel) ADCs and detection elements energized during the listening mode period.

In view of the above, what is proposed is a wireless configuration and methodology that effectively detects packet data by only using one of the ADC channels (i.e., I-channel OR Q-channel) elements while keeping the other ADC channel deactivated until a packet is detected. Upon detecting a packet, the previously deactivated ADC channel and associated elements are turned on, to enable the proper performance of the packet decoding process. The deactivation of one of the ADC channels during listening modes may result in significant power savings.

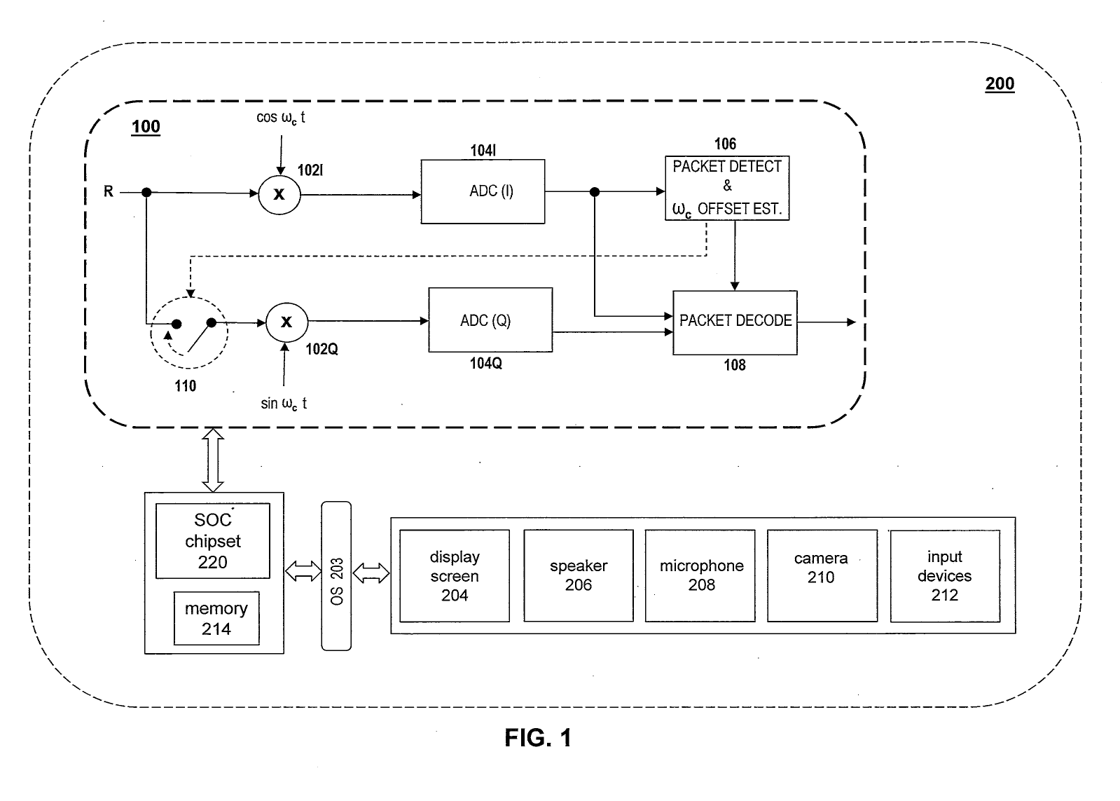

With this said, FIG. 1 depicts of a low power packet detection system 100 incorporated in a communications interface unit of wireless communication device 200, in accordance with various aspects of the present disclosure. By way of illustration, wireless communication device 200 may be designed to conduct wireless communications under various standards and protocols, such as, for example, Wi-Fi, WiMax, WWAN, WLAN, WPAN, BlueTooth, BlueTooth Low Energy, CDMA, GPRS, 3G or 4G, LTE, IEEE 802.11-based specifications, etc. In so doing, wireless communication device 200 may comprise, for example, a cellular/smart phone, laptop, mobile device, tablet computer, personal communication system (PCS) device, personal digital assistant (PDA), personal audio device (PAD), etc.

In the illustrative example, wireless communication device 200 includes a variety of peripherals, such as, for example, display screen 204, speaker 206, microphone 208, camera 210, input devices 212, etc. wireless as well as an operating system (OS) 203 to manage the software applications as well as the hardware devices and resources.

Moreover, wireless communication device 200 includes memory 214 and a system-on-chip (SoC) chipset 220. The wireless communication device 200 may also include a bus infrastructure and/or other interconnection means to connect and communicate information between the various components of communication device 200.

In some embodiments, SoC 220 may be part of a core processing or computing unit of wireless communication device 200, and is configured to receive and process input data and instructions, provide output and/or control other components of communication device 200 in accordance with embodiments of the present disclosure. SoC 220 may include a microprocessor, a memory controller, a memory and other components. The microprocessor may further include a cache memory (e.g., SRAM), which along with the memory of SoC 220 may be part of a memory hierarchy to store instructions and data. The microprocessor may also include one or more logic modules such as a field programmable gate array (FPGA) or other logic array. Communication between the SoC 220's microprocessor and memory may be facilitated by the memory controller (or chipset), which may also facilitate communication with the peripheral components.

Memory 214 of wireless communication device 200 may be a dynamic storage device coupled to the bus infrastructure and configured to store information, instructions, and programs to be executed by processors of SoC 220 and/or other processors (or controllers) associated with communication device 200. Some of all of memory 214 may be implemented as Dual In-line Memory Modules (DIMMs), and may be one or more of the following types of memory: Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDECSRAM, PCIOO SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), or any other type of memory device. Wireless communication device 200 may also include read only memory (ROM) and/or other static storage devices coupled to the bus infrastructure and configured to store static information and instructions for processors of SoC 220 and/or other processors (or controllers) associated with communication device 200.

Returning to FIG. 1, the architecture of packet detection system 100 of the communications interface unit of communication device 200 comprises two parallel ADC channel paths, an in-phase (I-channel) path and a quadrature-phase (Q-channel) path, packet detection and carrier frequency ω_{C} offset estimator unit 106, and a packet decoder unit 108.

During listening mode (i.e., while wireless communication device 200 is not in active communications), system 100 is configured to detect relevant packet data by only employing one of the two ADC channel paths and deactivating the other channel path. In the non-limiting embodiment of FIG. 1, the packet detection is performed by the I-channel path while Q-channel path is deactivated via switch mechanism 110. However, consistent with the principles of the instant disclosure, the Q-channel path may equally be configured to perform packet detection while the I-channel path is deactivated.

It should be appreciated that, for the sake of tractability and clarity, various standard receiver chain elements and details regarding those elements as well as the communication interface unit and packet decoder unit, such as, for example, antennae, low noise amplifiers, tuners, attenuators, filters, equalizer, forward error correction (FEC) decoders, timing and carrier recovery circuitry, phase-locked loops, etc. have been omitted, as such elements are not necessary for the understanding of the principles disclosed herein.

As shown in FIG. 1, along the I channel path, system 100 comprises down-converter 102I, ADC 104I while the Q channel path comprises switching mechanism 110, down-converter 102Q, and ADC 104Q. Down-converters 102I, 102Q are configured to down convert received signal R from a radio-frequency (RF)/intermediate-frequency (IF) signal to an analog baseband signal. Down-converter 102I mixes received signal R with a reference signal, cos(ω_{C}t), operating at carrier frequency ω_{C}. In like fashion, down-converter 102Q mixes received signal R with a reference signal, sin(ω_{C}t), also operating at carrier frequency ω_{C}.

It will be appreciated that reference signals cos(ω_{C}t), sin(ω_{C}t), may be outputted from a local oscillator, voltage controlled oscillator, numerically-controlled oscillator etc. (not shown). After down-converting, two orthogonally-shifted, analog, baseband, component signals are generated, namely an analog, baseband, I-component signal and an analog, baseband, Q-component signal, respectively.

The analog, baseband, I-component signal is inputted to ADC 104I, which is configured to sample the analog signal to generate digital I-component samples. Similarly, baseband, Q-component signal is inputted to ADC 104Q, which samples the analog signal to generate digital Q-component samples.

As noted above, during listening mode, the packet detection process is performed by one of the ADC channel paths while the other ADC channel path is deactivated. As depicted in FIG. 1, the I-channel path is powered on and coupled to the received signal R to perform packet detection while the Q-channel path is deactivated. As shown in the figure, Q-channel path is deactivated by having switch mechanism 110 disconnect the Q-channel path components from the received signal R. Alternately or in addition to, Q-channel path may be deactivated by having the switch operate on the local oscillator and/or by having the corresponding components disconnected from their power source.

Focusing on the activated I-channel path elements, received signal R is mixed with reference signal, cos(ω_{C}t), operating at carrier frequency ω_{C} by down-converter 102I to produce an analog, baseband, I-component signal which, in turn, is inputted to ADC 104I that samples the analog signal to generate digital I-component samples. These I-component samples are then forwarded to packet detection and carrier frequency ω_{C} offset estimator unit 106.

Unit 106 is configured to detect a relevant packet by looking for the start of an actual packet frame, namely looking for a preamble and/or a sync pattern. Unit 106 achieves the detection by analyzing cross-correlation peaks in the digital I-component samples and also provides an estimate of the carrier frequency ω_{C} offset.

In particular, unit 106 cross-correlates the I-component samples with a complex-valued reference pattern for consecutive, predetermined time intervals (e.g., every 0.4 μsec, 0.8 μsec, etc.). The reference pattern contains information similar to an actual packet frame preamble/sync pattern. The cross-correlation process generates values, in which the absolute values (i.e., magnitude of cross-correlation values) may be taken and compared to a predetermined threshold. When the magnitude of the cross-correlation values exceed the predetermined threshold, it is indicative of cross-correlation peaks and, consequently, the start of an actual packet frame. At such time, switch mechanism 110 is actuated to activate the Q-channel path components and couple those components to the received signal R in order for both digital I-component and Q-component samples to be processed by packet decoder unit 108.

As noted above, unit 106 is also configured to provide an estimate of the carrier frequency ω_{C} offset. That is, the cross-correlation values that exceed the predetermined threshold (i.e., representing cross-correlation peaks) also contain complex angle information due to the complex-valued reference pattern used to cross-correlate the digital I-component samples. In subsequent cross-correlation time intervals, the complex angle information is examined again and unit 106 determines how the complex angle information has changed during the time intervals. Unit 106 then estimates what the carrier frequency ω_{C} offset is and commensurately provides an offset correction value to compensate for the estimated carrier frequency ω_{C} offset. As such, how the complex angle information changes within the cross-correlation predetermined time intervals provides a measure of how the carrier frequency ω_{C} offset should be adjusted.

In particular, upon the cross-correlation values exceeding the predetermined threshold, the complex angle information is examined. Because of the deactivation of Q-component samples, the sign of the angle of the cross-correlation value may be either positive or negative, so initially it is unknown if the carrier frequency ω_{C} offset is positive or negative. Unit 106 may, therefore, guess at or assume a sign, and apply this guessed-at correction value to compensate for the carrier frequency ω_{C} offset. The cross-correlation values are recomputed. If the complex angle information indicates a residual carrier frequency offset of zero, the correct assumption was made. If the complex angle information indicates a residual carrier frequency offset of approximately twice the initial estimate, the incorrect assumption was made and the other sign for the carrier frequency estimate is chosen.

As an illustrative example, suppose that upon detecting a cross-correlation peak, the complex angle information indicates +0.2°, at which point, unit 106 introduces an initial carrier frequency ω_{C} offset correction value of −0.2° to packet decoder unit 108. In subsequent 0.8 μsec cross-correlation intervals, the complex angle information may indicate a rotation of +0.4°. Unit 106 then reverses the sign of the initial guess and provides to packet decoder unit 108 an offset correction value of +0.2° to compensate for the carrier frequency ω_{C} offset. In this example, had the initial correction value been selected as +0.2 degrees, then the subsequent measurement would have been approximately zero (e.g., exactly zero in the absence of noise).

It will be appreciated that the described embodiments are by way of example and are not intended to be limiting. As such, various modifications to the described embodiments may be implemented without departing from the principles of the disclosed subject matter. For example, IEEE 802.11b standards specify packet preamble comprising a time-domain BPSK-based signal as the packet preamble. It will be appreciated that the demodulation/decoding of BPSK signals only employ one ADC channel, either the I-channel or Q-channel—but not both, as the signal energy only exists in one of the channels.

However, the non-limiting embodiment of FIG. 1 may be modified to accommodate the detection of such BPSK preambles. For example, by intentionally introducing an artificial frequency offset φₐᵣₜ in the local oscillator of down-converter 102I, i.e., mixing the received signal R with cos(ω_{C}t+φₐᵣₜ), the signal energy of the BPSK signal will spill across both the I-channel and Q-channel. In addition, artificial frequency offset φₐᵣₜ may be introduced in the reference pattern used to identify cross-correlation peaks. In so doing, the configuration of system 100 will exploit the spilled energy in the ADC I-channel path to determine the cross-correlation peaks as well as estimate and correct for the actual carrier frequency ω_{C} offset.

In addition, with this configuration, when switching to full decode mode upon determining the beginning of a packet frame, the artificial frequency offset is also applied to the local oscillator of down-converter 102Q i.e., mixing the received signal R with sin(ω_{C}t+φₐᵣₜ. By using this technique, the sign ambiguity described above is avoided.

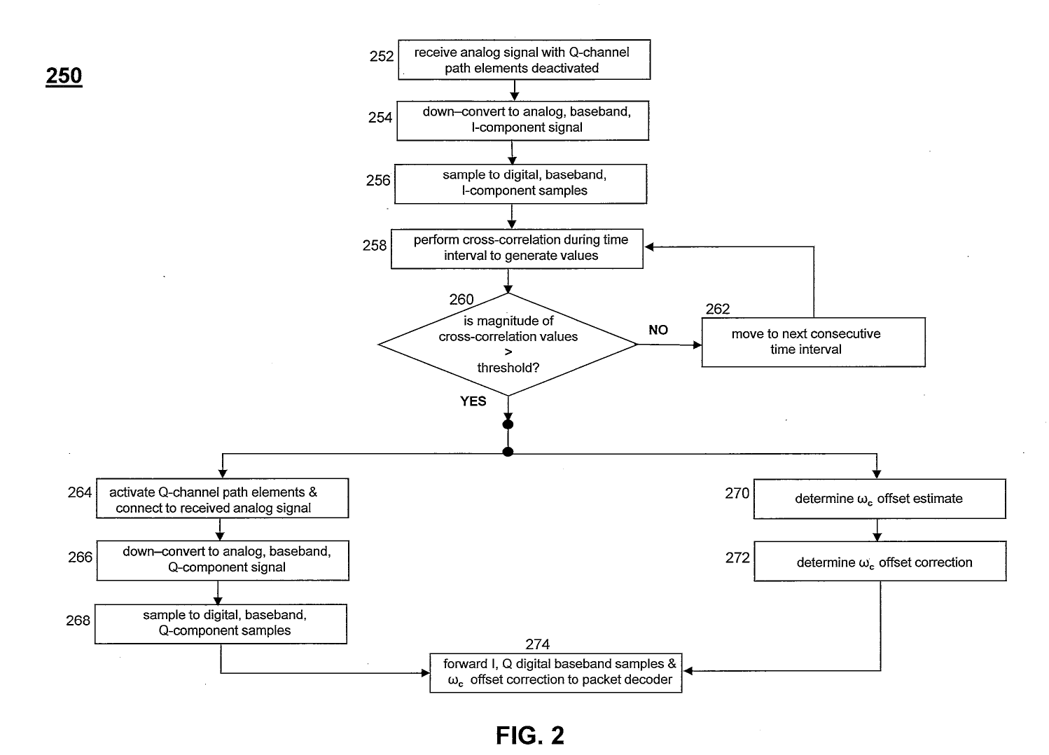

FIG. 2 illustrates a functional flow diagram of low power packet detection process 250 by a communications interface unit of a wireless communication device, in accordance with various aspects of the present disclosure. It will be appreciated that, in some embodiments, process 250 may be implemented in hardware, software, and/or firmware, and may also run on special purpose or general purpose computing platforms. The execution and control of various aspects may be implemented via one or more microprocessors or microcontrollers such as those made by Intel Corporation of Santa Clara, Calif. (although other vendors may be used). In certain embodiments, given high throughput requirements of certain communication systems, process 250 may run on more dedicated on-chip computing engines containing specialist signal processing building blocks such as FFTs and complex number arithmetic.

In other embodiments, process 250 may be implemented machine readable instructions for executing the various operations noted above. The machine readable instructions may be implemented in software stored on tangible computer readable media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or implemented in firmware or dedicated hardware in a well known manner (e.g., it may be implemented by an application specific integrated circuit (ASIC), a programmable logic device (PLD), a field programmable logic device (FPLD), a field programmable gate array (FPGA), discrete logic, or the like).

Returning to FIG. 2, process 250 begins at block 252, in which the analog (e.g., RF/IF) signal R is received while the ADC Q-channel path elements are deactivated and the ADC I-channel path elements are activated. As noted above, the Q-channel elements may be deactivated by having switch mechanism 110 disconnect the Q-channel path components from the received signal R. And, alternately or additionally, Q-channel path may be deactivated by having the switch operate on the local oscillator and/or by having the corresponding components disconnected from their power source.

At block 254, received signal R is mixed with reference signal, cos(ω_{C}t), operating at carrier frequency ω_{C} to produce an analog, baseband, I-component signal. The analog, baseband, I-component signal is then sampled, at block 256, to generate digital I-component samples.

At block 258, process 250 performs cross-correlation of the digital I-component samples with a reference pattern for consecutive, predetermined time intervals (e.g., cross-correlation time intervals of 0.4 μsec, 0.8 μsec, etc.). The cross-correlation process generates cross-correlation value in which, at block 260, the magnitude of cross-correlation values are compared to a predetermined threshold. If the of the cross-correlation values do not exceed the predetermined threshold, then at block 262, process 250 moves to the next consecutive cross-correlation time interval and performs cross-correlation of the digital I-component samples associated with that time interval.

If the magnitude of the cross-correlation values exceed the predetermined threshold, it is indicative of cross-correlation peaks and, consequently, the start of an actual packet frame. At such time, process 250 commences the activation of Q-channel elements as well as the determination of carrier frequency ω_{C} offset estimate. These two operations may be executed concurrently or in close timing to each other.

As such, at block 264, the Q-channel elements are activated and coupled to the received signal R and, at block 266, received signal R is mixed with reference signal, sin(ω_{C}t), operating at carrier frequency ω_{C} to produce an analog, baseband, Q-component signal. The analog, baseband, Q-component signal is then sampled, at block 268, to generate digital Q-component samples.

Concurrent with, or in close succession to, the Q-channel activation operation, process 250 executes the determination of carrier frequency ω_{C} offset estimate at block 270. As noted above, because the carrier frequency ω_{C} offset is initially unknown, an assumed carrier frequency ω_{C} offset correction sign is introduced to the packet decoding procedures. In subsequent cross-correlation time intervals, the complex angle information is examined again and process 250 determines how the complex angle information has changed during the corresponding time intervals to estimate what the carrier frequency ω_{C} offset is. Then, at block 272, process 250 provides an estimated carrier frequency ω_{C} offset correction.

Finally, at block 274, process 250 forwards the I-channel samples, Q-channel samples, and estimated carrier frequency ω_{C} offset correction to the packet decoding procedures.

Having thus described the novel concepts and principles of the optimization of carrier recovery performance, it will be apparent to those skilled in the art after reading this detailed disclosure that the foregoing detailed disclosure is intended to be presented by way of example only and is not limiting. Various alterations, improvements, and modifications will occur and are intended to those skilled in the art, though not expressly stated herein. The alterations, improvements, and modifications are intended to be suggested by this disclosure, and are within the spirit and scope of the exemplary aspects of this disclosure. Additionally, the recited order of processing elements or sequences, or the use of numbers, letters, or other designations therefore, is not intended to limit the claimed processes and methods to any order except as can be specified in the claims. Although the above disclosure discusses through various examples what is currently considered to be a variety of useful aspects of the disclosure, it is to be understood that such detail is solely for that purpose, and that the appended claims are not limited to the disclosed aspects, but, on the contrary, are intended to cover modifications and equivalent arrangements that are within the spirit and scope of the disclosed aspects.

What is claimed is:

1. A wireless device, comprising:
a communications interface unit configured to receive a wireless signal, the communications interface unit including:
a first channel path having a first down-converter to generate a first analog baseband signal based on the received wireless signal and a first analog-to-digital converter (ADC) to sample the first analog baseband signal and generate first digital samples;
a second channel path having a second down-converter that operates at a frequency orthogonal to the first down-converter and generates a second analog baseband signal based on the received wireless signal and a second ADC to sample the second analog baseband signal and generate second digital samples; and
a packet detector unit configured to detect a beginning frame of packet data,
wherein, the packet detector detects the beginning frame of the packet data based on only the first digital samples provided by the first channel path and the second channel path remains deactivated until the beginning frame of the packet data is detected.

2. The wireless device of claim 1, wherein the packet detector unit detects the beginning frame of the packet data by cross-correlating the first digital samples with a reference pattern containing information similar to a packet frame preamble and identifies cross-correlation peaks.

3. The wireless device of claim 2, wherein the cross-correlation produces cross-correlation values having amplitude and angle information.

4. The wireless device of claim 3, wherein the packet detector unit identifies cross-correlation peaks by comparing the magnitude of the cross-correlation values to a predetermined threshold.

5. The wireless device of claim 1, wherein the second channel path is deactivated by disconnecting the second down converter from the received wireless signal, deactivating a local oscillator of the second down converter, and/or disconnecting the second down-converter, the local oscillator, or the second ADC from their power source.

6. The wireless device of claim 1 wherein, in response to detecting the beginning frame of the packet data, the packet detector unit is configured to activate the second channel path by connecting the second down converter to the received wireless signal, activating the local oscillator of the second down converter, and/or connecting the second down-converter, the local oscillator, or the second ADC to their power source.

7. The wireless device of claim 6 wherein, in response to activating the second channel path, the first digital samples and the second digital samples are forwarded to a packet decoder unit.

8. The wireless device of claim 3, wherein the packet unit detector is further configured to estimate a carrier frequency offset and provide an estimated carrier frequency offset correction based on the cross-correlation value angle information.

9. The wireless device of claim 8, wherein the packet unit detector estimates the carrier frequency offset by introducing an assumed carrier frequency offset correction sign and examining the changes to the angle information of the cross-correlation values to determine the estimated carrier frequency offset correction.

10. The wireless device of claim 9 wherein, in response to detecting the beginning frame of the packet data, the estimated carrier frequency offset correction is forwarded to a packet decoder unit.

11. A method comprising:
receiving a wireless signal;
providing a first channel path that generates a first analog baseband signal based on the received wireless signal and that samples the first analog baseband signal to generate first digital samples;
providing a second channel path that generates a second analog baseband signal based on the received wireless signal that is orthogonal to the first analog baseband signal and that samples the second analog baseband signal to generate second digital samples;
detecting a beginning frame of packet data,
wherein, the detecting of the beginning frame of the packet data is based on only the first digital samples provided by the first channel path and the second channel path is deactivated until the beginning frame of the packet data is detected.

12. The method of claim 11, wherein the detecting of the beginning frame of the packet data is performed by cross-correlating the first digital samples with a reference pattern containing information similar to a packet frame preamble and identifying cross-correlation peaks.

13. The method of claim 12, wherein the cross-correlating produces cross-correlation values having amplitude and angle information.

14. The method of claim 13, wherein the identifying of the cross-correlation peaks is performed by comparing the magnitude of the cross-correlation values to a predetermined threshold.

15. The method of claim 11, wherein the deactivation of the second channel path is performed by disconnecting the second down converter from the received wireless signal, deactivating a local oscillator of the second down converter, and/or disconnecting the second down-converter, the local oscillator, or the second ADC disconnected from their power source.

16. The method of claim 11 wherein, in response to detecting the beginning frame of the packet data, activating the second channel path by connecting the second down converter to the received wireless signal, activating the local oscillator of the second down converter activated, and/or connecting the second down-converter, the local oscillator, or the second ADC connected to their power source.

17. The method of claim 16 wherein, in response to activating the second channel path, forwarding the first digital samples and the second digital samples to a packet decoder unit.

18. The method of claim 11, further comprising estimating a carrier frequency offset and provide an estimated carrier frequency offset correction based on the cross-correlation value angle information.

19. The method of claim 18, wherein the estimating of the carrier frequency offset is performed by introducing an assumed carrier frequency offset correction sign and examining the changes to the angle information of the cross-correlation values to determine the estimated carrier frequency offset correction.

20. The method of claim 19 wherein, in response to detecting the beginning frame of the packet data, forwarding the estimated carrier frequency offset correction to a packet decoder unit.
